(19) United States
(12) Patent Application Publication
(10) Pub. No.: US 2015/0239416 A1
(43) Pub. Date: Aug. 27, 2015

(54) AIRBAG BRACKET

(71) Applicant: Craig A. Markusic, Marysville, OH (US)

(72) Inventor: Craig A. Markusic, Marysville, OH (US)

(73) Assignee: HONDA MOTOR CO., LTD., Tokyo (JP)

(21) Appl. No.: 14/189,010

(22) Filed: Feb. 25, 2014

(51) Int. Cl. B60R 21/213; B60R 22/24; B60R 21/232

(52) U.S. Cl. CPC B60R 21/213; B60R 21/232; B60R 22/24; B60R 2021/161

(57) ABSTRACT

A structure for securing a curtain airbag to a vehicle including an airbag cushion disposed along a roof side rail of a vehicle having a side pillar, and adapted to be inflated in a curtain-like manner during a side-impact vehicle collision. The structure includes an airbag bracket for attaching the airbag to the vehicle body, and a support member having a first end secured to the vehicle side pillar and a second end receiving the airbag bracket.

### BACKGROUND

The present exemplary embodiment relates to an automotive vehicle airbag. It finds particular application in conjunction with a curtain airbag and more specifically with a mounting structure for a curtain airbag, and will be described with particular reference thereto. However, it is to be appreciated that the present exemplary embodiment is also amenable to other similar applications.

Modern vehicles are designed to provide a substantial degree of safety to passengers. One way in which this is accomplished is by including air bags to cushion the passengers during collisions. Air bags were first employed in front of either the driver, front seat passenger or both. Side curtain air bags have also been introduced and protect the vehicle occupants from injury during a side impact collision, rollover collision, or other accident where the passengers are more likely to move laterally.

Because a side curtain airbag must cover more area that a typical dashboard air bag, the side curtain air bag is larger in size. However, such an air bag must be inflated at a speed that is comparable to a dashboard-configured air bag. As a result, the inflator size and gas output velocity used for the side curtain air bag is typically much larger than that of a dashboard-configured inflator and must be strategically placed. Also, because the side curtain air bag is larger than dashboard-configured airbags, the direction of the deployment must be controlled to optimize its effectiveness during a collision. Controlling placement and deployment direction is rendered more difficult due to limited space along a vehicle's roofline, where the air bag is stored.

Unlike dashboard mounted air bags that deploy directly toward a vehicle occupant, it is desirable for a side curtain air bag to deploy downward, and as close to the side of the vehicle interior wall as possible. This path avoids an inadvertent collision with the vehicle occupant while the airbag is in the process of deploying and also ensures the most significant coverage.

One exemplary side curtain airbag assembly is shown in FIG. 1. Particularly, the airbag system includes an airbag module 10 that principally consists of an airbag 11 (illustrated in a deployed condition), a tension cloth 12 attached to a front end portion of the airbag 11, a diffuser pipe 13 and an inflator 14. The airbag 11 is adapted to inflate and deploy into a curtain-like shape along a side wall of the passenger compartment when it is supplied with gas.

A curtain airbag is typically attached to a vehicle roof rail along a vehicle interior side portion above a door opening of the vehicle body. In a normal state (when the curtain airbag is not deployed), the lower side of the curtain airbag is covered with a terminal portion of roof lining on a vehicle interior side. When an impact caused by collision or the like is experienced, the curtain airbag is unfolded downward from the roof side portion by the high-pressure gas (inflating gas), to form a passenger protective wall between the passenger and the vehicle body side portion. However, during a side impact, it is feasible for the vehicle side pillar (e.g. the vehicle b-pillar) or the pillar garnish to deform, wherein the side curtain airbag deployment could be effected by the displaced pillar or pillar garnish.

It would be desirable to provide a curtain air bag mounting arrangement wherein the air bag can be deployed within the passenger compartment with minimal likelihood of the airbag being undesirably impacted by a vehicle pillar or pillar garnish in the event the vehicle frame is distorted by the impact.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

According to a first embodiment, an arrangement structure for a curtain airbag, which includes an airbag cushion disposed along a roof side rail of a vehicle having a side pillar, and adapted to be inflated in a curtain-like manner during a side-impact vehicle collision is provided. The arrangement structure includes an airbag bracket for attaching the airbag to the vehicle body, and a support member having a first end secured to the vehicle side pillar and a second end receiving the airbag bracket.

According to a second embodiment, an automotive vehicle including a passenger restraint assembly having a side pillar, a roof rail, and a side curtain airbag assembly adapted to be inflated in a curtain-like manner during a side-impact vehicle collision is provided. A bracket secures the side curtain airbag assembly directly to the side pillar of the vehicle. The side curtain airbag assembly includes a mounting frame having a region joined to the bracket and a chamber configured to receive the folded side curtain.

### BRIEF DESCRIPTION OF THE DRAWINGS

FIG. 1 is a side view showing a passenger car equipped with a prior art side cushion airbag;

FIG. 2 is a perspective view of an automotive vehicle side pillar and inner roof rail in the area in which a side curtain airbag is positioned;

FIG. 3 is a side cross-section view taken along line 3-3 of FIG. 2;

FIG. 4 is a perspective view of the vehicle side pillar and inner roof rail of FIG. 2 wherein the side pillar garnish and the roof lining have been removed;

FIG. 5 is a schematic illustration of how the side curtain airbag mounting assembly of the present disclosure helps to maintain proper alignment of the side curtain airbag for unimpeded deployment; and

FIG. 6 is a schematic illustration of a seat belt attachment plate modified to include a side curtain airbag support bracket.

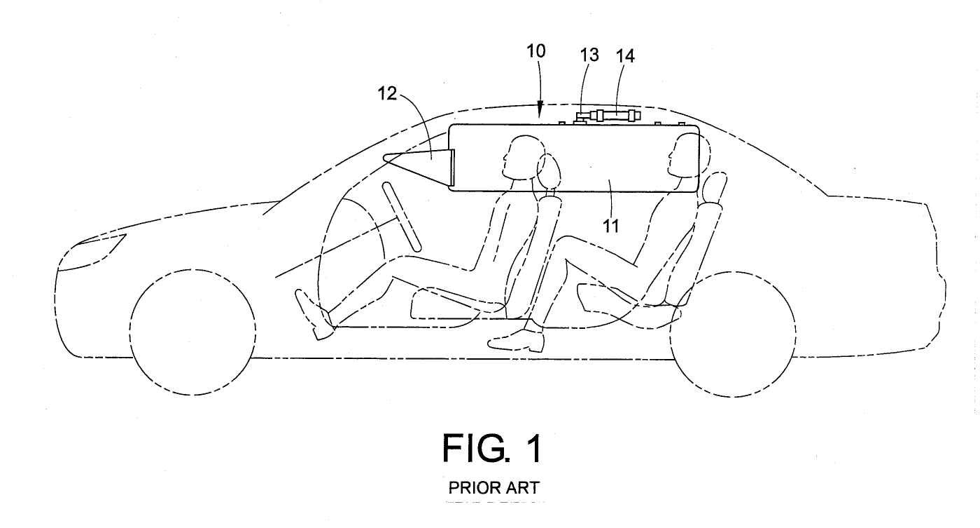

### DETAILED DESCRIPTION

Current technology may not maintain a desirable relationship between a side curtain airbag, the vehicle side pillar, and the side pillar garnish during a crash. The result is that current side curtain airbags are being designed to deploy more inboard to clear the garnish during a crash. A more inboard trajectory can deploy in the direction of an occupants head and/or become hung up on a vehicle head rest. The present disclosure sets forth a mechanism of attaching a side curtain airbag to a vehicle which maintains its preferred placement adjacent the roof rail and minimizes the likelihood that a displace side pillar garnish will influence proper deployment.

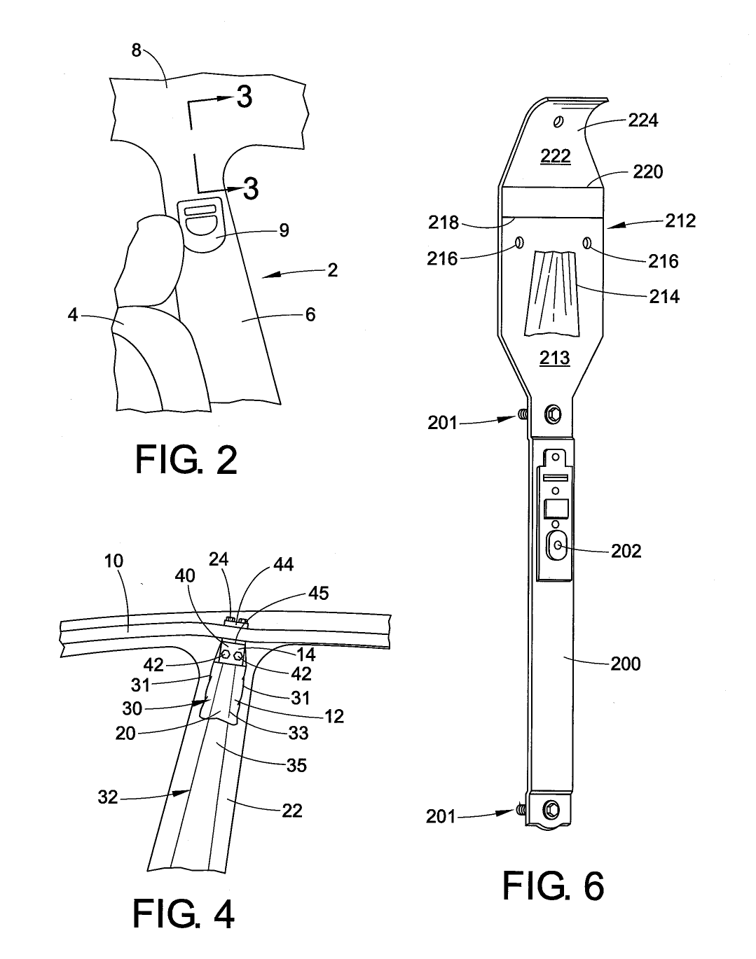

A first exemplary embodiment will be described with reference to FIGS. 2-4. Turning first to FIG. 2, a vehicle interior side wall 2 is depicted. The vehicle side wall 2 is adjacent to a passenger seat 4. Vehicle side wall 2 includes a garnish 6 overlying a vehicle side pillar (not visible), and a roof lining 8 overlying an inner roof rail (not visible). Also visible is a seat belt slider garnish 9, behind which can be disposed a D-ring attachment assembly (not visible) that is secured to the vehicle side pillar.

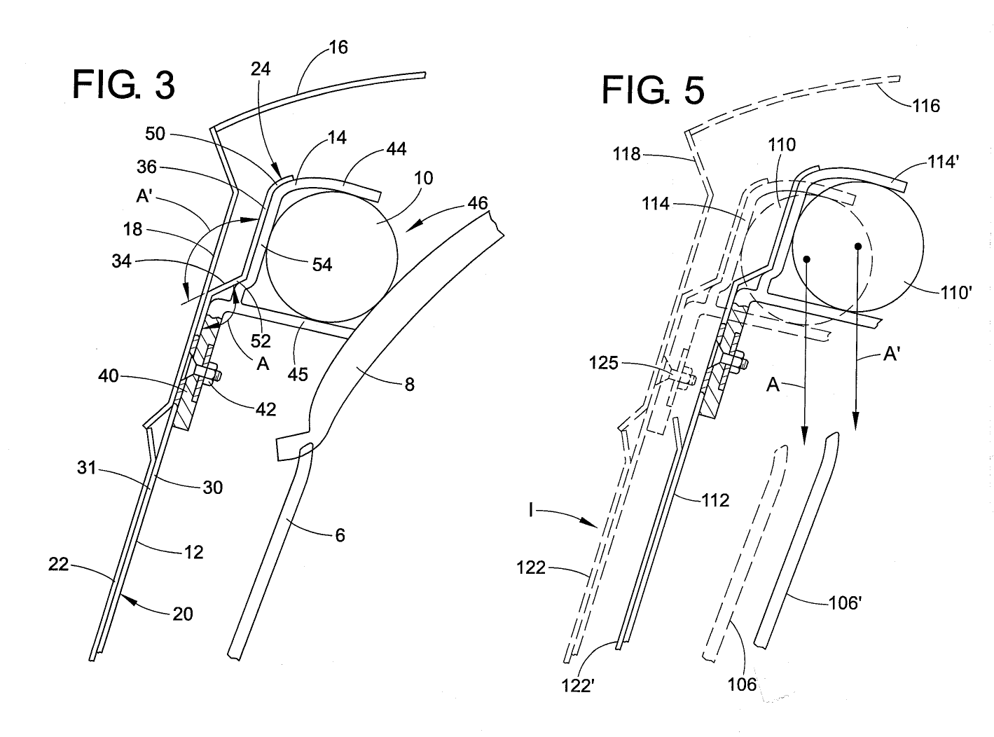

Referring now to FIGS. 3 and 4, an airbag module 10 containing a curtain style airbag is secured to a vehicle by a support member 12 and an airbag bracket 14. The support member 12 in combination with the airbag bracket 14 position the airbag module 10 between the roof lining 8, a roof arch stiffener 16 and a roof rail 18.

Since the airbag module 10 is similar to what is conventional art, a detailed description thereof will be omitted. Similarly, although a particular airbag bracket configuration is depicted herein, the intent of the disclosure is not believed to be limited to that specific design. Rather, it is anticipated that a variety of airbag bracket shapes can benefit from the present disclosure.

The support member 12 includes a first end 20 fixed to a side pillar 22 of the vehicle and a second end 24 disposed between the roof arch stiffener 16, roof rail 18, and roof lining 8. The side pillar can be, for example, either or both of what are typically referred to as the vehicle B and/or C pillar.

Support member 12 can be formed of any suitable material, of which steel, aluminum or fiber reinforced plastic are examples. In addition, although one specific airbag bracket and one specific airbag module is depicted, it is envisioned that the support member 12 of the present disclosure is functional with most if not all traditional airbag modules and their associated airbag bracket(s).

The first end 20 of support member 12 can be attached to the side pillar 22 by any means known in the art, including for example spot welding or bolting. In the event bolting is utilized, it may be desirable to perform the attachment using existing through holes, such as those used for attachment of a seat belt assembly. In fact, it is envisioned that the present support bracket can form a further element of a seat belt D-ring adjustment bracket (see FIG. 6; described herein below).

The support member 12 can have a first generally vertical and substantially planar region 30 that is mated to the side pillar 22. In this regard, the side pillar 22 can have a generally vertical orientation and a generally elongated shape with a generally planar inner surface 32 receiving planar region 30 of the support member 12. At least a portion of planar region 30 of support member 12 and at least a portion of the planar inner surface 32 of side pillar 22 can reside in at least substantially parallel planes. As used herein, the term planar is intended to encompass a planar region 30 having edges 31 which are at least substantially coplanar. Moreover, it is envisioned that the support member 12 could include a protrusion 33 that is received within a channel 35 formed in side pillar 22. This configuration can provide increased torsional strength in each of the side pillar 22 and the support member 12.

Alternatively, the surfaces of the side pillar and support member which are in contact in the region of the bolted or welded connection may not be generally planar but can include complimentary surfaces which facilitate the formation of a desirable interface. For example, it is envisioned that the support member can be in the form of a tube received within a correspondingly shaped channel in the side pillar.

Support member 12 also includes an angled intermediate wall 34 which joins planar region 30 to a head region 36. Head region 36 can be shaped to cooperatively mate with a portion of airbag bracket 14. Angled intermediate wall 34 can be tangential to region 30 of the support member or may have an angle departing from 90 degrees. Head region 36 which receives airbag bracket 14 can similarly be angled relative to intermediate wall 34. According to an exemplary embodiment, the included angle “A” between region 30 and wall 34 can be at least substantially the same as the included angle “A” between head region 36 and wall 34. In this manner, region 30 and head region 36 can lie in at least substantially parallel planes.

The airbag bracket 14 can include a generally vertical area 40 contacting the first planar region 30 of the support member 12. The airbag bracket 14 can be bolted 42 (or otherwise secured via welding for example) at this point of contact. The airbag bracket 14 can further include generally horizontally extending shelves 44 and 45 defining a receptacle 46 that receives and retains airbag module 10. Head region 36 of the support member 12 can include at least several points of contact (see 50 and 52) with a rear side 54 airbag bracket 14 adjacent to the area in which the receptacle 46 is formed to provide mechanical support thereto. In this manner airbag module 10 can best retain its alignment with the longitudinal axis of the side pillar during displacement thereof.

With particular reference to FIG. 5, the benefit of maintaining alignment between the side pillar of the vehicle and the airbag module is visually depicted. Particularly, an original position of side pillar 122, roof rail 118, roof arch stiffener 116, side pillar garnish 106, and a side curtain airbag containing bracket 114 are depicted in dashed lines. What is shown in dashed lines is a traditional approach to attachment of a side curtain airbag device where the airbag bracket 114 is bolted (see bolt 125) to the roof rail 118.

As demonstrated by arrow A, in an original position, release of the airbag from module 110 travels to the vehicle inboard side of side pillar garnish 106 to provide effective lateral passenger protection. However, if the vehicle were to experience a side impact force in a direction depicted by arrow I, the side pillar 122′ and the side pillar garnish 106′ can be forced inwardly (shifted components are depicted in solid line). Since the airbag bracket 114 is affixed to the roof rail 118, and the roof rail 118 can be prevented from significant inward deformation by roof arch stiffener 116, the airbag bracket 114 does not shift inward to the same extent as the side pillar 122 and side pillar garnish 106. As demonstrated by arrow A, the shifted side pillar garnish 106′ can prove to be an impediment to proper airbag deployment. More particularly, the roof arch stiffener can prevent the inner roof rail from deforming to the same extent as the side pillar and side pillar garnish, causing miss-alignment of the side curtain airbag bracket and the pillar garnish.

However, by utilizing support bracket 112 to join side curtain airbag bracket 114′ directly to the side pillar 122′, the airbag bracket 114′ travels inboard in conjunction with the force I. Accordingly, the proper deployment relationship between the airbag and the side pillar garnish 106′ can be maintained and the side curtain airbag will still properly deploy within the passenger compartment. This relationship between airbag deployment and the inwardly shifted position of the side pillar garnish 106′ can be discerned from the direction of arrow “A′”. As a result, the airbag can be rapidly and stably deployed into the automobile to cover the entire inner side part of the automobile, thereby protecting a driver/passenger from injury.

Referring now to FIG. 6, an alternative embodiment of the present disclosure is provided. Particularly, a common seat belt assembly includes a seat belt anchor affixed to a side pillar of a vehicle. A typical arrangement may provide for an adjustable D-ring and may include a button assembly, a rail, a base, a slider and a plate. According to the present disclosure, it is contemplated that a seat belt assembly may include an elongated rail 200 that is affixed to the vehicle side pillar by a pair of bolts 201. The rail 200 can include a series of openings 202 that are adapted to selectively receive the components of the seat belt assembly such as the pin of the button assembly. In accord with the present disclosure, the elongated rail 200 of the seat belt assembly can be manufactured to include a support bracket 212 constructed in a similar manner as the earlier describe support bracket(s). Particularly, support bracket 212 can include a projection 214 configured to be received within a recess in the side pillar and through holes and/or integral nuts 216 situated to receive bolts from an associated airbag bracket. A first bend 218 and a second bed 220 can lead to a first planar segment 222 suitable for receiving a rear surface of an airbag bracket. A rounded terminal portion 224 can similarly provide points of contact in support of the horizontal wall of the airbag bracket (see 44 of FIG. 3).

Advantageously, the present disclosure provides a side curtain airbag attachment that helps to maintain the relative relationship of the airbag, side pillar, and the pillar garnish during a vehicle side impact. The present support bracket helps to maintain a desired spacial relationship between the side pillar, side pillar garnish, and airbag allowing the side curtain airbag to deploy correctly.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An arrangement structure for a curtain airbag, which includes an airbag cushion disposed along a roof side rail of a vehicle having a side pillar, and adapted to be inflated in a curtain-like manner during a side-impact vehicle collision, the structure comprising:
an airbag bracket for attaching said airbag to a vehicle body, and
a support member comprised of one of steel and aluminum having a first end secured to the vehicle side pillar and a second end receiving said airbag bracket, wherein said support member directly joins said airbag bracket to said side pillar.

2. (canceled)

3. The arrangement structure as defined in claim 1, wherein said support member is welded to said side pillar.

4. The arrangement structure as defined in claim 1, wherein said airbag bracket is one of welded or bolted to said support member.

5. The arrangement structure as defined in claim 1, wherein said support member includes a first substantially planar region, and a second substantially planar region, said first and second regions interconnected by an angled wall.

6. The arrangement structure of claim 5, wherein said first substantially planar region and said second substantially planar region reside in at least generally parallel planes.

7. The arrangement structure of claim 6, wherein said side pillar includes an elongated extent defining an at least substantially planar surface, said planar surface of the side pillar residing at least generally in a plane that is parallel to the generally parallel planes of said first and second substantially planar regions of said support member.

8. The arrangement structure of claim 5, wherein said first substantially planar region is secured to said side pillar and said second substantially planar region receives said airbag bracket.

9. The arrangement structure of claim 7, wherein said second substantially planar region and said planar surface of the side pillar remain in at least generally parallel planes subsequent to a side impact.

10. The arrangement structure of claim 1, wherein said support member is bolted to said side pillar via through holes also forming a point of attachment for a seat belt mechanism.

11. The arrangement structure of claim 1, wherein said support member forms a component of a seat belt mechanism.

12. The arrangement structure of claim 5, wherein an included angle between said first planar region and the angled wall is substantially equal to an included angle between said second planar region and the angled wall.

13. The arrangement structure of claim 7, wherein said first planar region includes a protrusion configured to be received within a channel formed in said side pillar.

14. An automotive vehicle including a passenger restraint assembly comprising a side pillar, a roof rail, a side curtain airbag assembly adapted to be inflated in a curtain-like manner during a side-impact vehicle collision, and a bracket securing said side curtain airbag assembly to the vehicle;
said side curtain airbag assembly including a mounting frame having a region joined to said bracket and a chamber configured to receive a folded side curtain;
said bracket including a first region welded or bolted to said side pillar and a second region disposed adjacent said chamber of the curtain airbag assembly, said first region residing generally in a first plane and said second region residing generally in a second plane, said second region being spaced from said side pillar, and said first plane and said second plane being at least substantially parallel; and
wherein said bracket directly joins said side curtain airbag assembly to said side pillar.

15. The vehicle of claim 14, wherein said bracket is one of welded or bolted to said side pillar.

16. (canceled)

17. The vehicle of claim 14, wherein said first region further includes a projection shaped to be received within a channel formed in said side pillar.

18. A bracket for securing a curtain airbag assembly to an associated vehicle, said bracket comprising a first region mounted to a side pillar of the associated vehicle including at least two through-holes or nuts for receiving at least two bolts associated with said airbag assembly, a second region shaped to have at least two points of contact with said airbag assembly, a first bend forming a terminal end of the first region, a second bend forming a terminal end of the second region, the first bend and the second bend connected by a wall, said wall creating a space between the bracket and the side pillar adjacent the airbag assembly, an included angle of said first bend and an included angle of said second bend being at least substantially equal.

19. The bracket of claim 18 including a projection disposed on the first region and shaped to be received within a recess formed in a side pillar of the associated vehicle.

20. The bracket of claim 18 being formed as an integral component of a seat belt mounting assembly.

21. The automotive vehicle of claim 14, wherein the region of said mounting frame joined to said bracket comprises a first end of the mounting frame and wherein a second end of the mounting frame terminates in a planar portion, said planar portion residing at least substantially perpendicular to the side pillar.

22. The automotive vehicle of claim 14 wherein an intermediate region of said bracket engages a roof rail.
